(19) United States
(12) Patent Application Publication
(10) Pub. No.: US 2024/0013126 A1
(43) Pub. Date: Jan. 11, 2024

(54) DATA RELIABILITY INDEX

(71) Applicant: SAP SE, Walldorf (DE)

(72) Inventors: Joerg FRANKE, Bruchsal (DE); Ulrich SCHLUETER, Schriesheim (DE); Michel LOEHDEN, Rimbach (DE); Florian ROLL, Köln (DE)

(21) Appl. No.: 17/859,333

(22) Filed: Jul. 7, 2022

(51) Int. Cl. G06Q 10/06; G06F 16/22

(52) U.S. Cl. CPC G06Q 10/06393; G06F 16/22

(57) ABSTRACT

Some embodiments include a system, method, and non-transitory medium, with the method including receiving a specification of one or more influence factors related to a set of reporting data, the set of reporting data including at least one reporting attribute; designating a weight factor to each of the one or more influence factors for each of the at least one reporting attribute; generating, based on the specification of the one or more influence factors and the weight factor designated to each of the one or more influence factors, a reliability index for the at least one reporting attribute; and storing a record of the generated reliability index in a data storage device.

### BACKGROUND

An individual, organization, or enterprise may currently use or desire to use reporting data to, for example, gain insights into the status of a process, organization, system, or other entity. The reporting data might be generated based on an analysis of the process, organization, system, or other entity. In some instances, the reporting data might be presented in one or more reports, graphs, charts, and other visualizations that may typically be designed to convey summaries or snapshots of certain aspects (e.g., processes, key performance indicators (KPIs), etc.) of the process, organization, and system related to the reporting data.

In some instances, reporting data (e.g., financial data, organization performance metrics data, etc.) might not be reliable for various reasons. Such reasons might include, for example, financial postings are not yet complete for a given period, postings are not yet approved or verified, data validation rules have not yet been applied, data validation rules show outliers that require manual verification, data validation rules show errors, auditor activities have not yet finished, allocation of cost(s) to business entities are not complete, there pending legal claim(s) that will affect the reporting numbers, technical error(s) have been identified while recording the postings, key subject matter experts have not yet reviewed or verified the reporting data, etc.

In a number of different contexts and instances, reporting data may be used, at least in part, in a decision-making process. Reporting data in the form of, for example, financial data for an organization might be used or referenced by executives, directors, owners, and other individuals in the organization when they make decisions and plan actions related to the operation(s) of the organization. As an example, a chief executive officer of an enterprise might refer to a balance sheet, profit and loss statement (P&L), cash flow statement, other financial reports, as well as other types of reporting data, when making decisions regarding operational and strategic plans and operations for the enterprise. As such, the information in the reporting data may be critically vital to the business. Given the significance of the reporting data, it would be beneficial to know whether the reporting data (e.g., calculated numbers, KPI values, etc.) are worthy of being relied upon. That is, are the reporting data sufficiently complete and accurate to an extent that it is worthy of being relied upon?

Accordingly, it would therefore be desirable to provide an indication of data reliability with the actual reporting data, to be able to directly relate both.

### BRIEF DESCRIPTION OF THE DRAWINGS

FIG. 1 is an illustrative example of a block diagram for a reliability index system, according to some exemplary embodiments;

FIG. 2 is an illustrative depiction of a high level architecture for a reliability index system, according to some exemplary embodiments

FIG. 3 is an illustrative depiction of a representation of reporting data as presented to a user, according to some exemplary embodiments;

FIG. 4 is an illustrative depiction of a representation of reliability data, according to some exemplary embodiments;

FIG. 5 is an illustrative depiction of visualization including reporting data and reliability data associated therewith, according to some exemplary embodiments;

FIG. 6 is an illustrative flow diagram for a process, according to some exemplary embodiments;

FIG. 7 is an illustrative depiction of user interface, according to some exemplary embodiments;

FIG. 8 is an illustrative flow diagram for another process, according to some exemplary embodiments;

FIG. 9 is an outward facing user interface related to a system and process for reliability indices, according to some exemplary embodiments; and

FIG. 10 is an example of a computer system useful for implementing various embodiments.

Throughout the drawings and the detailed description, unless otherwise described, the same drawing reference numerals will be understood to refer to the same elements, features, and structures. The relative size and depiction of these elements may be exaggerated or adjusted for clarity, illustration, and convenience.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

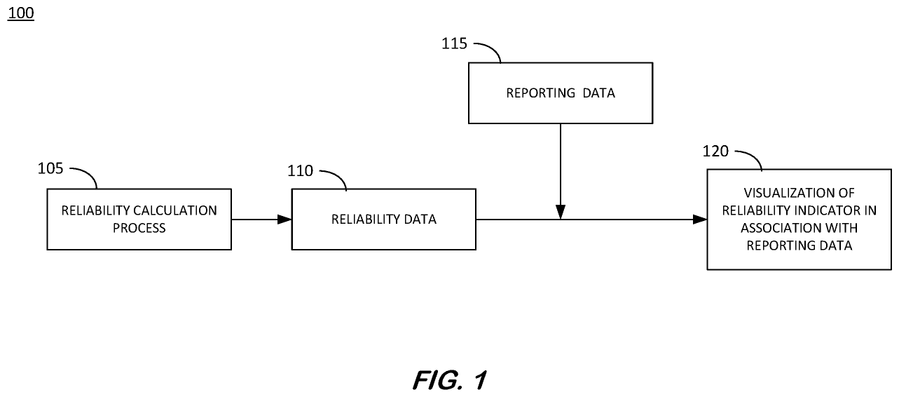

Provided herein are system, method and/or computer program product embodiments, and/or combinations and sub-combinations thereof, to provide and support a generation of a reliability index for a set of reporting data, where the reliability index is determined based on one of more influence factors for the reporting data. For example, FIG. 1 is an illustrative example of a functional block diagram for a reliability index system 100, according to some embodiments.

In some embodiments, block diagram 100 in FIG. 1 might represent aspects of a reliability index system where the reliability calculation process 110 and a visualization process 120 might be implemented by a combination of hardware components (devices, systems, etc.) and software components (executable applications, routines, instructions, services, etc.) deployed on one or more nodes, pods, or clusters of on-premises, cloud-based, and hybrid-cloud computing resources. In some embodiments, reporting data 115 is provided to or otherwise received by reliability index system 100. In some aspects, reporting data 115 may include various types of data that might be used to generate reports, including for example, KPIs included in dashboards and other visualizations, organization internal reports, and disclosures that might be released to the public. In one illustrative example, reporting data 115 might comprise financial accounting data for an organization, including some or all of the accounting data and financial statements related to the organization including revenues, expenses, assets, liabilities, and equity.

In some aspects, the reporting data 115 may include a set (or subset) of the data, financial data or other data, that is generated by, accessible to, or otherwise used by an organization or other entity to perform processes related to the subject of a report. In the example of a dashboard or report including KPIs related to sales of a company's products in different regions of the world, the reporting data may include the financial data typically generated and used by the company's accounting department. That is, in some embodiments herein the reporting data 115 may be (financial) data that is generated, accessed by, or otherwise known to the company.

Referring to FIG. 1, reliability data 110 might include a reliability index generated by a reliability calculation process 105. Reliability data 110 may provide, as represented by the reliability index, an indication or gauge of a trustworthiness, soundness, and veracity of an aspect (e.g., attribute, dimension, etc.) of reporting data 115 to which the reliability index is associated. The reliability calculation process 105 might consider one or more factors that influence a specific aspect (e.g., attribute or dimension) of reporting data 115. As used herein, the one or more factors that influence a specific aspect of reporting data 115 are referred to as “influence factors”. As an illustrative example, consider a general ledger (GL) account of a general ledger for a company that has one influence factor. The one influence factor in this example is whether the GL account is closed for postings for the current fiscal period. For reporting data 115 including this GL account (i.e., attribute or dimension), the single influence factor may be used to calculate a reliability index as either 100% or 0%, where the reliability index=0% in the instance the GL account is still open for postings for the current fiscal period and the reliability index=100% in the instance this GL account is closed for postings for the current fiscal period.

Referring again to FIG. 1, the reliability data (e.g., a reliability index) 110 and the reporting data 115 associated therewith may be combined and presented in a visualization 120. In some aspects, by including the reliability index of the reliability data 110 and the reporting data 115 it is associated with in the same visualization (e.g., report, chart, graph, interactive dashboard, animation, etc.), an indication of the reliability (i.e., trustworthy, sound, and accurate) of the reporting data is also presented directly in the visualization. In this manner, a reader/user of this example visualization can see, directly in the visualization without a need to look elsewhere (e.g., another report, system, or device), how reliable the reporting data (e.g., GL account) is based on the associated reliability index (e.g., 0%, “not reliable” or 100%, “reliable”) included in the same visualization. In the example including a GL account with the single influence factor, a person referring to the visualization in a decision-making role may decide to delay making an operational or strategic decision relying on the GL account in the instance the reliability index is 0%, whereas they might proceed to rely on the reported numbers for the GL account in the instance the reliability index calculated for it is 100%.

Unless otherwise stated, the reliability calculation process(es) techniques that may be used to generate the reliability data herein are not limited to any particular reliability calculation technique, process, or algorithm if otherwise applicable and compatible with other aspects herein.

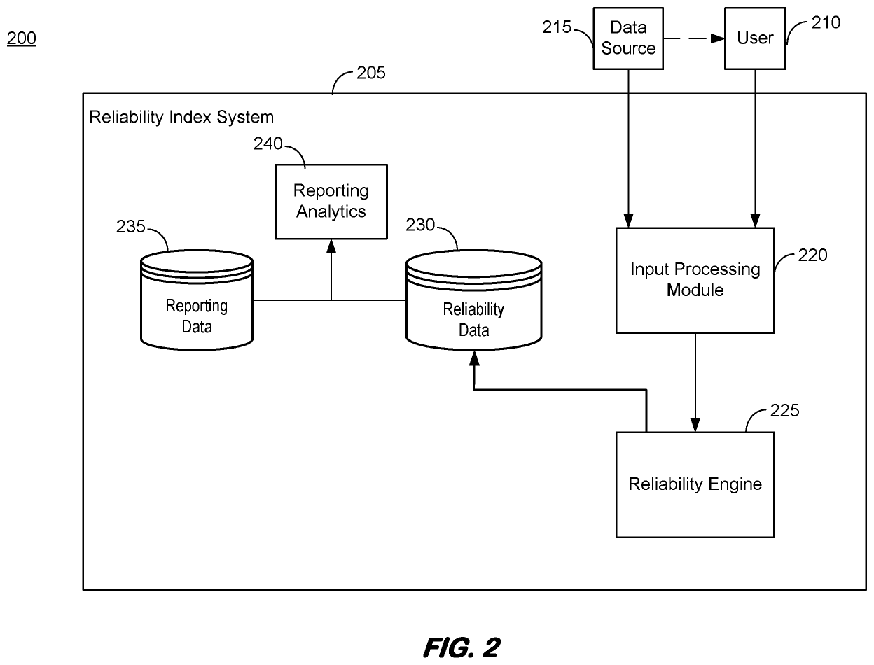

FIG. 2 is an illustrative depiction of a high-level architecture 200 including a reliability index system 205, according to some exemplary embodiments. In some aspects, architecture 200 embodies some of the functionality depicted in the reliability index system 100 in FIG. 1.

As shown, reliability index system 205 includes a reliability engine 225 that receives, as inputs thereto, a specification of influence factors received from at least one of user(s) 210 and data sources 215 via input processing module 220. In some embodiments, user(s) 210, acting in their capacity or role with an organization and possessing knowledge or an understanding of the influence factors related to a set of reporting data, may provide a specification of influence factors for the set of reporting data. In some instances, user(s) 210 may receive at least a portion of the influence factors they provide to reliability index system from data sources 215. That is, user(s) 210 might not necessarily have the knowledge to determine the influence factors related to a certain set of reporting data but might receive such information from data sources 215 and provide that information as an input to input processing module 220.

In some embodiments, input processing module 220 might process information received from user(s) 210 and data sources 215 that includes one or more influencer factors for a set or reporting data to, for example, configure the received specification of influence factors into a format and configuration that is compatible with the data requirements of reliability engine 225. For example, in some instances the specification of influence factors received from the user(s) and data sources might be processed by input processing module 220 to correlate the specified influence factors with particular attributes of the set of reporting data, in accordance with one or more rules and processes of input processing module 220, reliability engine 225, and other aspects of reliability index system 205. For example, input processing module 220 might correlate a particular field in a table (or other data structure) representation of a set of reporting data to a specified influence factor received from user(s) 210 and data sources 215.

In some aspects, there may be a variety and number of different data sources 215 that can provide information useful in specifying the influence factors for a set of reporting data since, for example, a set of reporting data might vary depending on a domain of the reporting data (e.g., financial data for a subsidiary of a global company), a use case or reporting event (e.g., end of month financial reporting, end of fiscal year reporting, public disclosure reporting, audit reports, etc.), and other considerations. As such, data sources 215 may include one or more reporting systems, analytical systems, databases, knowledge bases, data repositories, social networks, news feeds, business or organization data generating systems, and the like. Input processing module 220 may receive a specification of the influence factors for a particular set of reporting data, where the specification identifies, for example, the particular influence factors associated or related to the set of reporting data.

In some embodiments, the influence factors received from user(s) 210 and data sources 215 might include influence factors determined to be most relevant to a set of reporting data. In some other embodiments, the influence factors received from user(s) 210 and data sources 215 might include potential influence factors for a set of reporting data, wherein input processing module 220 or reliability engine 225 might determine which of the potential influence factors are relevant for a particular set of reporting data. The relevancy of the influence factors for a particular set of reporting data might, in some instances, depend on a use case or reporting event for the reporting data.

In some instances, influence factors for reporting data might differ from entity to entity. For example, the influence factor(s) for a first company might be different for a second company, even for similar types of reporting data since the two companies might employ different processes to generate the reporting data and/or place a greater importance of the on different attributes of the reporting data (e.g., use different KPIs, etc.). In some embodiments, reliability index system 205 provides a mechanism for a user entity 210 to configure and specify the influence factor(s). In this manner, user(s) 210 may specify influence factors defined for their company, organization, specific use case, etc., whereas influence factors need not be universally defined and applicable to all entities and applications equally. In some aspects, input process module 220 might support a graphical user interface with which user(s) 210 can provide inputs specifying influence factors for a set of reporting data.

In some embodiments, reliability index system 205 provides a mechanism for user(s) 210 to configure and designate a weight (e.g., a relative value) to the influence factors specified for a set of reporting data. As an example, a user 210 might designate a weight to one or more influence factors including GL accounts of the reporting data for a company. In this example, a first GL account might be designated relatively low weight of 2% since it relates to a recently acquired business division and the acquired business division has not, at least yet, impacted the financial status of the company. Accordingly, this particular GL account is not presently particularly relevant regarding the set of reporting data for the company. In some aspects, input process module 220 might support a graphical user interface with which user(s) 210 can provide inputs specifying a weight or other relative value to apply to influence factors specified for a set of reporting data.

Reliability engine 225 may calculate reliability data, including a reliability index or other indices for specific associated attributes or dimensions of reporting data. The reliability engine may use the specified influence factors and a weight designated to each influence factor for a set of reporting data, as received from input processing module 220, in calculating or otherwise determining the reliability index for the attributes of the reporting data. In some aspects, one or more relationships, algorithms, and processes may be used by reliability engine 225 to generate the reliability data that may be stored in a reliability database 230. Given the variety of reporting data, specified influence factors, and potential individuality of weights designated to the specified influence factors, the one or more relationships, algorithms, and processes used by reliability engine 225 to generate the reliability data may also accordingly vary to accommodate and support different types and sets of reporting data and use cases. As such, the relationships, algorithms, and processes used by reliability engine 225 to generate the reliability data in some embodiments herein is not limited to any specific reliability calculation relationship, algorithm, and process.

Reliability index system 205 may operate to combine or otherwise associate the calculated reliability data stored in reliability database 230 and the set of reporting data related to the determined reliability data. As illustrated in FIG. 2, the reporting data may be stored in reporting database 235. In some embodiments, reporting database 235 is managed and maintained separately and distinctly from reliability database 230. In some instances, there may be a desire or requirement (e.g., for organization/institutional, legal, or regulatory compliance) for the reporting data to be persisted in its own database (e.g., the reporting data is financial data that must be strictly maintained or regulatory auditing compliance). In some instances, the reporting data in reporting database 230 might not be updated once it is committed to the database.

In some embodiments, reliability data (e.g., a reliability index for the at least one attribute for a set of reporting data) might be recalculated or regenerated to update the reliability index. In some instances, the reliability data might be updated in response to at least one of a manual input and a trigger from an autonomous system associated with the set of reporting data. The manual or autonomous inputs may be provided to a reliability index system herein as the reporting data associated with the influence factors used to calculate the reliability data change. For example, as reporting data is continuously (e.g., daily financial numbers) or periodically (e.g., monthly, quarterly, and year end financial numbers) generated, the influence factors and weights associated therewith might also change. The changed values for the influence factors and weights associated therewith may be used to recalculate or regenerate the reliability data (e.g., an updated reliability index for an attribute of a set of reporting data). Accordingly, the reliability data stored in reliability database 225 may be recalculated multiple different times.

Reliability index system 205 may further operate to generate a visualization including a representation of the combination of the set of reporting data and the generated reliability index corresponding to at least one attribute of the reporting data associated therewith. In some embodiments, the generated reliability index corresponding to the at least one reporting attribute is, within the generated visualization, spatially associated with the representation of the value for the at least one attribute for the set of reporting data. In this manner, the generated visualization clearly (i.e., intuitively) conveys which attribute of the set of reporting data is associated with the generated reliability index. As such, a viewer of the generated visualization may readily and directly observe, in one location, the association between the generated reliability index and the attribute for the set of reporting data correlated therewith.

Regarding possible use cases or reporting events (note, these terms are used interchangeably herein) for the reporting data, example use cases might include a scenario where (1) a reliability index is included inside of a report; (2) a reliability index is presented in a dashboard in association with reporting data including, for example, (financial or other) KPIs; (3) a calculated reliability index is used by a notification system or service (e.g., an alert system that generates an alert when a monitored KPI deviates more than a predefined threshold from a set value or range of values); and other reporting events. These examples of use cases possible for reliability data generated in some embodiments herein are not meant to be exhaustive, but instead illustrative.

Another example of a possible use case for reliability data generated in some embodiments herein includes using the generated reliability as a driver or trigger for a process related to a set of reporting data. As an example, consider an accounting process (e.g., an accounting year end closing procedure) that should be 50% complete according to an established timeline. However, reliability data generated in accordance with some embodiments herein states the accounting data generated by the accounting process is only 25% reliable. That is, the timeline for the accounting process is at the 50% point where the reporting data should be expected to be about 50% reliable, but the reliability data generated for this reporting data indicates the reporting data is only 25% reliable (e.g., only 25% of the requisite year data is posted). In this scenario, the reliability data including a reliability index of 25% for the reporting data related to the accounting process may be considered by an entity (e.g., a manager, a business process system, etc.) to, for example, make a decision regarding how to best allocate resources to complete the accounting process in a timely manner (e.g., before the end of the year). For this example scenario, the 25% reliability index might signal there is an issue with the year end closing process and the manager, informed by the calculated reliability index, might allocate more resources to the year end closing process so that it is actually completed before the end of the year. In this manner, reliability data generated in accordance with some embodiments herein might be used by other process (e.g., trigger or invoke manual or autonomous actions).

In some embodiments, reliability data generated herein might be used to navigate to an explanation or display a message describing, for example, how the reliability data was generated or the influence factor(s) considered in determining the reliability factor. For example, selecting a reliability index included in a dashboard in association with a set of particular reporting data might cause (1) the presentation of a pop-up window that includes an explanation or display a message describing the basis for the reliability index calculation, and (2) a navigation to an application or service that explains the calculation of the reliability index. In some embodiments, reliability data generated herein might be used in analytical situations to invoke an alert or message where the reliability data is used by an analytical system, process, or service and an alert or message is transmitted when the reliability data satisfies an alert or messaging condition. The alert or messaging condition may be defined by a rule, algorithm, or other mechanism executed by the analytical system, process, or service.

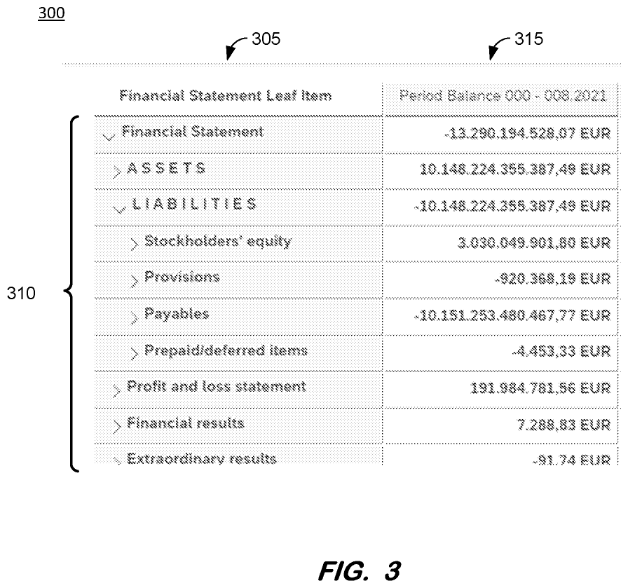

FIG. 3 is an illustrative depiction of a representation of an example of reporting data, according to some exemplary embodiments. In particular, reporting data 300 includes a portion of a balance sheet hierarchy for a financial statement including assets, liabilities, etc. in column 305. Each line item 310 of the financial statement lists a reported value in column 315. In some aspects, reporting data 300 may relate to a total or top-level of an organization, where the organization might include a plurality of (legal) entities. In some embodiments, reporting data 300 might be expanded to include financial statement columns similar to columns 305 and 310 for at least one or more of the plurality of entities.

While the example of reporting data disclosed in FIG. 3 and discussed in various examples herein may include financial data, reporting data herein is not necessarily limited to being financial data unless otherwise stated.

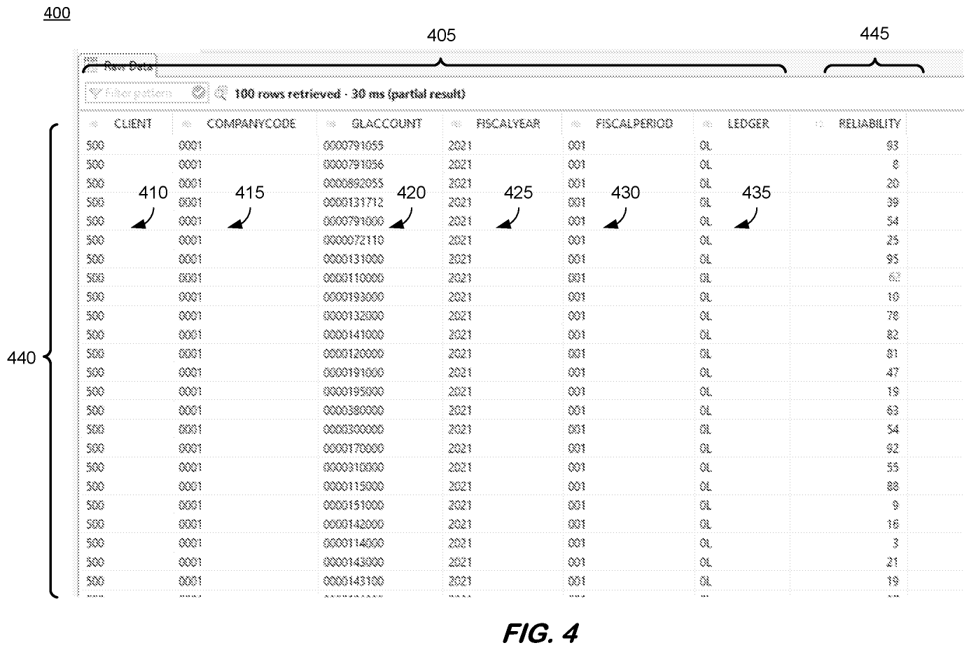

FIG. 4 is an illustrative depiction of a representation of reliability data 400, according to some exemplary embodiments. Reliability data 400 represents a database table with dimensions 405 including a client 410, a company code 415, a GL account 420, a fiscal year 425, a fiscal period 430, and ledger 435. For each combination of attributes (i.e., each line item 440), a calculated reliability index is provided in column 445. In some embodiments, the reliability index 445 for each line item might be used to calculate an aggregate (i.e., overall) reliability index for an entity.

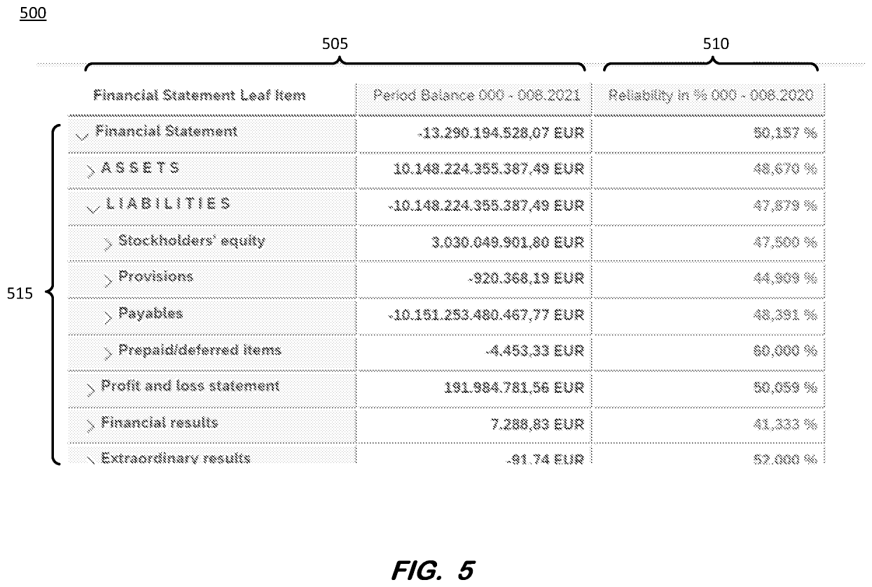

FIG. 5 is an illustrative depiction of visualization 500 including reporting data and reliability data associated therewith, according to some exemplary embodiments. As illustrated, visualization 500 includes a combination of reporting data 505 and reliability data 510, where the reliability index for a particular attribute may be presented in association with the reporting data to which it corresponds. For example, in then example of FIG. 5 the reliability index for a particular reporting data attribute is presented on the same line of the visualization as the reporting data attribute to which it corresponds. In this manner, the visualization efficiently and concisely conveys the reliability index and its associated reporting data attribute in a same interface.

In some embodiments, a visualization might include a presentation of reliability data generated in accordance with other aspects disclosed herein. For example, a visualization might be generated that includes, at least in one instance, generated reliability data in isolation. Such a visualization might simply include reliability data presented in a configuration similar to, for example, the column of reliability data 510 in FIG. 5.

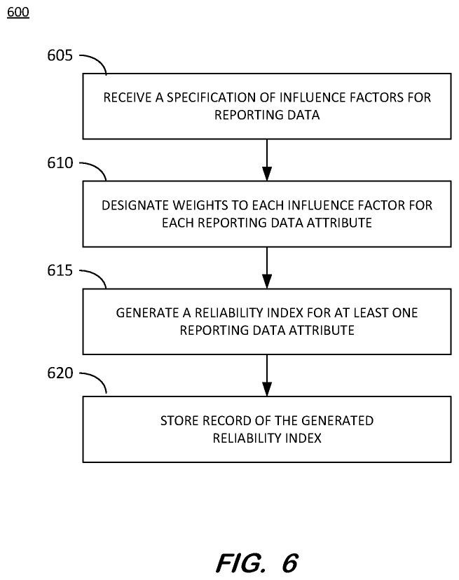

FIG. 6 is an illustrative flow diagram for a process 600, according to some exemplary embodiments. Process 600 might be performed by some or all of the elements of an embodiment described herein (e.g., reliability indication system 100 and 205. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein. Some aspects of process 600 have been disclosed in the discussion of FIGS. 1 and 2 and might be further understood by a reference thereto.

Operation 605 includes receiving a specification of one or more influence factors related to a set of reporting data. The set of reporting data may include at least one reporting attribute to which the specified influence factors correspond. The influence factors may be specified by a user, system, or service. In some instances, the specified influence factors might be revised or updated, for example, in response to the associated reporting data evolving or changing, the process(es) generating the reporting data changing, an understanding of what actually impacts or influences a set of reporting data evolving or changing, and other considerations.

At operation 610, a weight or other relative value factor may be designated to each of the one or more influence factors for each of the at least one reporting attribute. In some embodiments, the weight factor might be a percentage value, where the total weight for all influence factors for an attribute of a set of reporting data might not exceed 100%. In some embodiments, the weight factor designated to an influence factor might be revised or updated, for example, in response to a user or system (e.g., machine learning systems and models, etc.) gaining a better understanding and knowledge and reporting data changes. In some regards, the weight designated to an influence factor may be updated or revised to better reflect a true/real-world impact of the influence factor as knowledge of the behavior or performance of the influence factor evolves.

Continuing to operation 615, a reliability index may be generated for the at least one reporting attribute based on the received specification of the one or more influence factors and the weight factor designated to each of the one or more influence factors. Additional factors and considerations may be used in calculating the reliability index. One or more specific equations, relationships, algorithms, and processes might be used to generate the reliability index at operation 615, which rely, at least in part, on the specified influence factors and the weights designated thereto.

In some aspects, the generated reliability index might be a percentage value (i.e., on a scale of 0-100 percent), a color-coded index (e.g., red for low reliability, yellow for moderate reliability, and green for high reliability), a ranked value (e.g., on a scale of 1-5, 1-10, etc.), a positive or negative index, other relative values, and combinations thereof

At operation 620, a record of the generated reliability index may be stored in a data storage device. In some embodiments, the data storage device may include a database. In some instances, the database might include a cloud-based database. In some aspects, the record of the generated reliability index may be accessed by a system, device, or service, or for use in another process (not shown in FIG. 6).

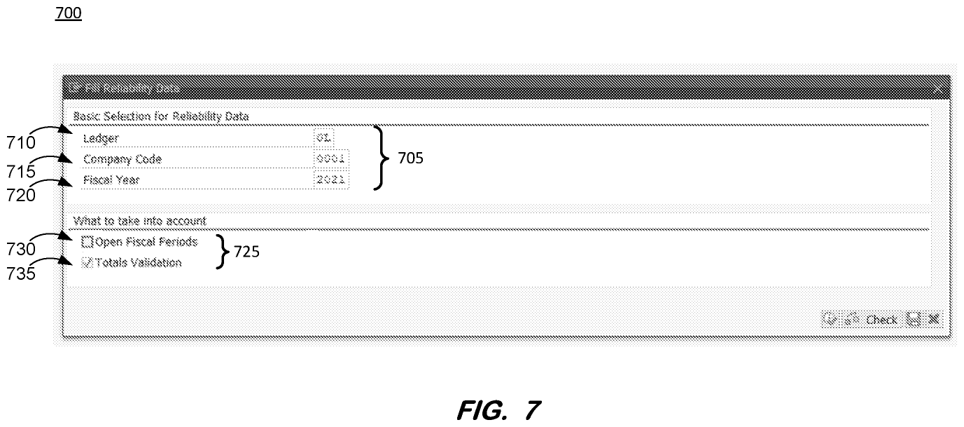

FIG. 7 is an illustrative depiction of an example user interface (UI) 700, according to some exemplary embodiments. UI 700 may be accessed by or presented to a user for the purpose of receiving user inputs that define a set of reporting data 705 for which reliability data is to be generated. In some embodiments, the user-specified inputs might be received from the user via, for example, the input processing module 220 depicted in FIG. 2. In the example of FIG. 7, a user may specify a combination of reporting data attributes (i.e., a set of reporting data) including a particular ledger 710, company code 715, and fiscal year 720 and the influence factors 725 associated with the selected reporting data. For the example of FIG. 7, UI 700 includes an option for a user to select or specify the influence factor of open fiscal periods at 730 and an option to select, at 735, an influence factor of a totals validation process that checks to see if a reported total adheres to one or more defined rules or constraints associated with the reported total. UI 700 is an example of a UI that may be compatible with some embodiments herein, where the present disclosure is not limited to the example of FIG. 7.

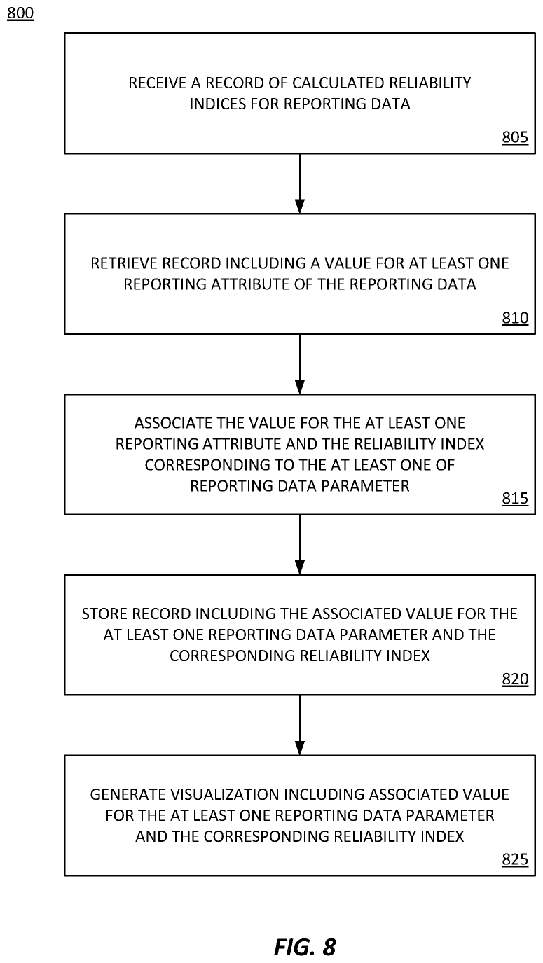

FIG. 8 is an illustrative flow diagram for a process 800, according to some exemplary embodiments. Process 800 might relate to a use of a generated reliability index. Operation 805 includes receiving a record of a generated reliability index for the set of reporting data. In one embodiment, the record of the generated reliability index might be retrieved or received from a reliability database (e.g., FIG. 2, 230). At operation 810, a record including a value for at least one reporting attribute of the set of reporting data corresponding to the reliability data received at operation 605 may be retrieved. In one embodiment, the record of the reporting data value be retrieved from a reporting database (e.g., FIG. 2, 235).

Continuing to operation 815, the value for the at least one reporting attribute for the set of reporting data is associated with the generated reliability index corresponding to the at least one reporting attribute for the set of reporting data. The combination of the value for the at least one reporting attribute for the set of reporting data and the associated generated reliability index corresponding to the at least one reporting attribute is stored in a record (or other data structure) at operation 820.

At operation 825, process 800 operates to generate a visualization including a representation of the value for the at least one reporting attribute for the set of reporting data and the generated reliability index corresponding to the at least one reporting attribute associated therewith. In some embodiments, as illustrated in FIG. 5, the generated reliability index corresponding to the at least one reporting attribute is, within the generated visualization, spatially associated with the representation of the value for the at least one reporting attribute for the set of reporting data.

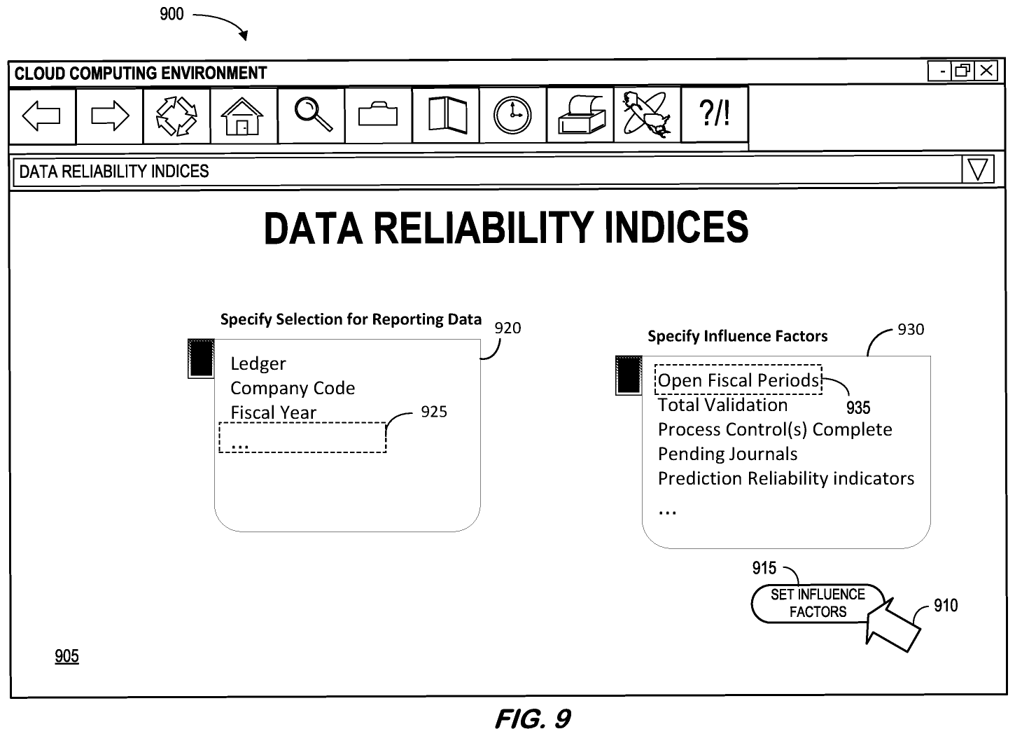

FIG. 9 is an outward facing user interface related to a system and process for data reliability indices, according to some embodiments. FIG. 9 is a human-machine interface display 900 in accordance with some embodiments. The display 900 includes a graphical representation 905 or dashboard that might be used to interact with a data reliability index system to provide inputs thereto and receive outputs therefrom. In particular, selection of an element (e.g., selecting set influence factors” entry button 915 by cursor 910) might result in the display of one or more popup windows 920 and 930 that accept user input entries for a data reliability index system from a user. Window 920 includes a plurality of attributes of a set of reporting data that may be selected by a user, where a selected attribute is shown highlighted at 925. Additionally, user input representing a specification of one or more influence factors 930 may be facilitated by the UI of display 900. In the example of FIG. 9, the influence factor “Open Fiscal Periods” is shown as being selected at 935.

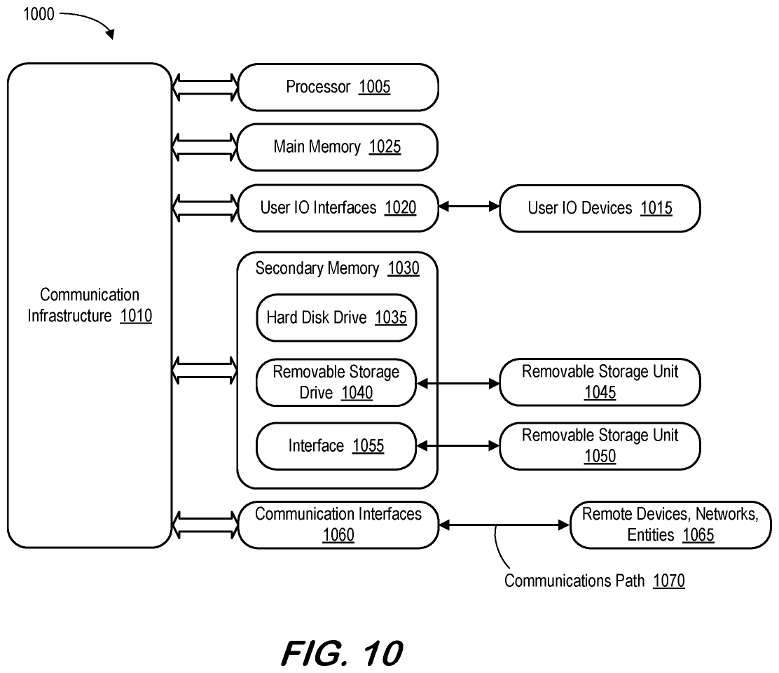

Various embodiments of a data reliability index system can be implemented, for example, using one or more well-known computer systems, such as computer system 1000 shown in FIG. 10. The computer system 1000 can be any computer capable of performing the functions described herein. Computer system 1000 includes one or more processors (also called CPUs), such as a processor 1005. Processor 1005 is connected to a communication infrastructure or bus 1010.

One or more processors 1005 may each be a Graphics Processing Unit (“GPU”). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 also includes user input/output device(s) 1015, such as monitors, keyboards, pointing devices, etc., that communicate with communication infrastructure xx06 through user input/output interface(s) 1020.

Computer system 1000 also includes a main or primary memory 1025, such as Random-Access Memory (“RAM”). Main memory 1025 may include one or more levels of cache. Main memory 1025 has stored therein control logic (i.e., computer software) and/or data.

Computer system 1000 may also include one or more secondary storage devices or memory 1030. Secondary memory 1030 may include, for example, a hard disk drive 1035 and/or a removable storage device or drive 1040. Removable storage drive 1040 may be a floppy disk drive, a magnetic tape drive, a compact disk drive, an optical storage device, tape backup device, and/or any other storage device/drive.

Removable storage drive 1040 may interact with a removable storage unit 1045. Removable storage unit 1045 includes a computer usable or readable storage device having stored thereon computer software (control logic) and/or data. Removable storage unit 1045 may be a floppy disk, magnetic tape, compact disk, DVD, optical storage disk, and/any other computer data storage device. Removable storage drive 1040 reads from and/or writes to removable storage unit 1045 in a well-known manner.

According to an exemplary embodiment, secondary memory 1030 may include other means, instrumentalities or other approaches for allowing computer programs and/or other instructions and/or data to be accessed by computer system 1000. Such means, instrumentalities or other approaches may include, for example, a removable storage unit 1050 and an interface 1055. Examples of the removable storage unit 1050 and the interface 1055 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1060. Communication interface 1060 enables computer system 1000 to communicate and interact with any combination of remote devices, remote networks, remote entities, etc. (individually and collectively referenced by reference number 1065). For example, communication interface 1060 may allow computer system 1000 to communicate with remote devices 1065 over communications path 1070, which may be wired and/or wireless, and which may include any combination of LANs, WANs, the Internet, etc. Control logic and/or data may be transmitted to and from computer system 1000 via communication path 10100.

In an embodiment, a tangible apparatus or article of manufacture comprising a tangible computer useable or readable medium having control logic (software) stored thereon is also referred to herein as a computer program product or program storage device. This includes, but is not limited to, computer system 1000, main memory 1025, secondary memory 1030, and removable storage units 1045 and 1050, as well as tangible articles of manufacture embodying any combination of the foregoing. Such control logic, when executed by one or more data processing devices (such as computer system 1000), causes such data processing devices to operate as described herein.

Based on the present disclosure, it will be apparent to persons skilled in the relevant art(s) how to make and use embodiments of the invention using data processing devices, computer systems and/or computer architectures other than that shown in FIG. 10. In particular, embodiments may operate with software, hardware, and/or operating system implementations other than those described herein.

Although specific hardware and data configurations have been described herein, note that any number of other configurations may be provided in accordance with some embodiments of the present invention (e.g., some of the information associated with the databases and storage elements described herein may be combined or stored in external systems). Moreover, although some embodiments are focused on particular types of applications and services, any of the embodiments described herein could be applied to other types of applications and services. In addition, the displays shown herein are provided only as examples, and any other type of user interface could be implemented.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims

1. A system comprising:
a memory storing processor-executable program code; and
a processing unit to execute the processor-executable program code to cause the system to:
receive a specification of one or more influence factors related to a set of reporting data, the set of reporting data including at least one reporting attribute;
designate a weight factor to each of the one or more influence factors for each of the at least one reporting attribute;
generate, based on the specification of the one or more influence factors and the weight factor designated to each of the one or more influence factors, a reliability index for the at least one reporting attribute; and
store a record of the generated reliability index in a data storage device.

2. The system of claim 1, wherein the generated reliability index is formatted as at least one of a percentage value, a color-coded index, a ranked value, a positive or negative index, and combinations thereof.

3. The system of claim 1, further comprising the processing unit to execute the processor-executable program code to cause the system to:
designate the one or more influence factors to specific attributes of the at least one reporting attribute.

4. The system of claim 1, wherein the reliability index for the at least one reporting attribute is regenerated to update the reliability index, the reliability index being updated in response to at least one of a manual input and a trigger from an autonomous system associated with the set of reporting data.

5. The system of claim 1, further comprising the processing unit to execute the processor-executable program code to cause the system to:
receive a record of the generated reliability index for the set of reporting data;
retrieve a record including a value for at least one reporting attribute of the set of reporting data;
associate the value for the at least one reporting attribute for the set of reporting data and the generated reliability index corresponding to the at least one reporting attribute for the set of reporting data; and
store a record of the value for the at least one reporting attribute for the set of reporting data associated with the generated reliability index corresponding to the at least one reporting attribute.

6. The system of claim 5 further comprising the processing unit to execute the processor-executable program code to cause the system to:
generate a visualization including a representation of the value for the at least one reporting attribute for the set of reporting data and the generated reliability index corresponding to the at least one reporting attribute associated therewith.

7. The system of claim 6, wherein the generated reliability index corresponding to the at least one reporting attribute is, within the generated visualization, spatially associated with the representation of the value for the at least one reporting attribute for the set of reporting data.

8. A computer-implemented method, the method comprising:
receiving, by a processor, a specification of one or more influence factors related to a set of reporting data, the set of reporting data including at least one reporting attribute;
designating, by the processor, a weight factor to each of the one or more influence factors for each of the at least one reporting attribute;
generating, by the processor based on the specification of the one or more influence factors and the weight factor designated to each of the one or more influence factors, a reliability index for the at least one reporting attribute; and
storing, by the processor, a record of the generated reliability index in a data storage device.

9. The method of claim 8, wherein the generated reliability index is formatted as at least one of a percentage value, a color-coded index, a ranked value, a positive or negative index, and combinations thereof

10. The method of claim 8, further comprising designating the one or more influence factors to specific attributes of the at least one reporting attribute.

11. The method of claim 8, wherein the reliability index for the at least one reporting attribute is regenerated to update the reliability index, the reliability index being updated in response to at least one of a manual input and a trigger from an autonomous system associated with the set of reporting data.

12. The method of claim 8, further comprising:
receiving, by the processor, a record of the generated reliability index for the set of reporting data;
retrieving, by the processor, a record including a value for at least one reporting attribute of the set of reporting data;
associating, by the processor, the value for the at least one reporting attribute for the set of reporting data and the generated reliability index corresponding to the at least one reporting attribute for the set of reporting data; and
storing a record of the value for the at least one reporting attribute for the set of reporting data associated with the generated reliability index corresponding to the at least one reporting attribute.

13. The method of claim 12 further comprising generating a visualization including a representation of the value for the at least one reporting attribute for the set of reporting data and the generated reliability index corresponding to the at least one reporting attribute associated therewith.

14. The method of claim 13, wherein the generated reliability index corresponding to the at least one reporting attribute is, within the generated visualization, spatially associated with the representation of the value for the at least one reporting attribute for the set of reporting data.

15. A non-transient, computer-readable medium storing instructions to be executed by a processor to perform a method, the method comprising:
receiving a specification of one or more influence factors related to a set of reporting data, the set of reporting data including at least one reporting attribute;
designating signing a weight factor to each of the one or more influence factors for each of the at least one reporting attribute;
generating, based on the specification of the one or more influence factors and the weight factor designated to each of the one or more influence factors, a reliability index for the at least one reporting attribute; and
storing a record of the generated reliability index in a data storage device.

16. The medium of claim 15, wherein the generated reliability index is formatted as at least one of a percentage value, a color-coded index, a ranked value, a positive or negative index, and combinations thereof

17. The medium of claim 15, wherein the method to be performed by the processor executing the stored instructions thereon further comprises designating the one or more influence factors to specific attributes of the at least one reporting attribute.

18. The medium of claim 15, wherein the reliability index for the at least one reporting attribute is regenerated to update the reliability index, the reliability index being updated in response to at least one of a manual input and a trigger from an autonomous system associated with the set of reporting data.

19. The medium of claim 15, wherein the method to be performed by the processor executing the stored instructions thereon further comprises:
receiving a record of the generated reliability index for the set of reporting data;
retrieving a record including a value for at least one reporting attribute of the set of reporting data;
associating the value for the at least one reporting attribute for the set of reporting data and the generated reliability index corresponding to the at least one reporting attribute for the set of reporting data; and
storing a record of the value for the at least one reporting attribute for the set of reporting data associated with the generated reliability index corresponding to the at least one reporting attribute.

20. The medium of claim 19 further comprising generating a visualization including a representation of the value for the at least one reporting attribute for the set of reporting data and the generated reliability index corresponding to the at least one reporting attribute associated therewith.
